(19) United States
(12) Patent Application Publication
(10) Pub. No.: US 2016/0078529 A1
(43) Pub. Date: Mar. 17, 2016

(54) SYSTEM AND METHOD FOR MAPPING AND MONITORING DEPOSIT CHANNELS

(71) Applicant: Early Warning Services, LLC, Scottsdale, AZ (US)

(72) Inventors: Ronald Scott Alcorn, Austin, TX (US); Jie He, Austin, TX (US); Tony Selway, Phoenix, AZ (US)

(73) Assignee: EARLY WARNING SERVICES, LLC, Scottsdale, AZ (US)

(21) Appl. No.: 14/487,652

(22) Filed: Sep. 16, 2014

(51) Int. Cl. G06Q 40/02; G06Q 20/04

(52) U.S. Cl. CPC G06Q 40/02; G06Q 20/042

(57) ABSTRACT

In order to prevent false positives at a duplicate transaction detection system, channel deposit data from financial institutions (representing the manner of presentment of checks at those institutions) are provided to a channel mapping/monitoring system. The channel mapping monitoring system calculates a prediction interval representing a normal expected range of deposits in any given channel. If deposits at a financial institution fall outside the normal expected range, the channel mapping/monitoring system provides an alert to the financial institution.

### BACKGROUND OF THE INVENTION

Banks and other institutions often use information on deposit channels to reduce the risk from fraudulent use of duplicate checks and other negotiable instruments. A “deposit channel” is the manner in which a check is presented to a bank for payment. Certain types of deposit channels may pose a greater risk than others, e.g., a deposit using the capture of a digital image of a check at a portable device may involve more risk than the deposit of the check at a teller window where identification can be requested by the teller if the person presenting the check is not known.

Systems have been developed for using deposit channel information to assess risk of fraud, e.g., risk associated with a person attempting to deposit the same check multiple times. The presentment of a check more than once, and a manner of presentment, can be used to alert a financial system as to possible fraud. One such system is described in co-pending and commonly assigned U.S. application Ser. No. 13/451,039, for SYSTEM AND METHOD FOR DETECTING AND MITIGATING DUPLICATE TRANSACTION FRAUD, filed Apr. 19, 2012 by Anthony J. Selway, et al., which is hereby incorporated by reference in its entirety for all purposes.

Assessing risk based on deposit channel information can sometimes be made difficult by systems and processes maintained within banks, where the deposit channel information may be used inconsistently or may inadvertently change over time in ways that do not accurately reflect the actual manner in which the checks (items) are being been deposited. The manner of deposit may be entered manually or may be automatically captured by banking systems at the time of deposit to reflect current processes used within a bank. For expediency, bank personnel may lump certain types of deposits together. Or in other instances, a single check transaction may be designated as having more than one type of presentment. For example, a bank might have an internal practice of designating an ACH transaction as both an electronic ACH transaction and as a presentment of a paper check at a teller window, to permit the bank to track the transaction both electronically and in paper. Also, in some cases the channel deposit designations may be ambiguous (to a person or system responsible for using the designations), and a single check may be entered twice with different deposit channel information, so that it is likely to reflect at least one accurate designation. As a result, some items may be indicated as being in two different channels and thus appear to be duplicate presentments, even though only one item has actually been presented. This results in a “false positive” (an item appearing to be presented more than once for deposit and thus falsely suggesting possible fraud), which can be an inconvenience to the bank and to its customer, whose deposit may be put on hold pending the resolution of the false positive. This may lead to time and cost for the bank in order to resolve the false positive, and loss of goodwill among customers affected by a false positive.

It is desirable for a bank to monitor deposit channels to avoid false positives and make duplicate item notifications more accurate.

### BRIEF SUMMARY OF THE INVENTION

There is provided, in accordance with embodiments of the present invention, a network/system and method for mapping deposit channel information over reference time periods at financial institutions and then monitoring presentments of instruments to the financial institutions for significant variations from expected deposit channel activity.

In one embodiment, a method for monitoring presentation of instruments to a financial institution includes receiving, from a financial institution, reference deposit channel information for each of a plurality of instruments presented to that financial institution, the reference deposit channel information representing instrument presentations into different deposit channels at the financial institution over each of a plurality of reference time periods; and mapping the reference deposit channel information for the plurality of reference time periods, to derive data reflecting the relative number of instrument presentations into each of the deposit channels for each of the plurality of reference time periods. The method further includes calculating, from the mapped reference deposit channel information for the plurality of reference time periods, predicted interval information representing an expected range of instrument presentations for each deposit channel that would reflect expected variations in deposit channel information; and receiving deposit channel information from the financial institution for a given time period under review in order to monitor the deposit channel information for that time period under review. The deposit channel information for each deposit channel for the time period under review is compared to the predicted interval information in order to determine if any deposit channel during the time period under review falls outside expected range of instrument presentations.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram showing a network in which a plurality of financial institutions communicate with a duplicate transaction detection system and a channel mapping system.

FIG. 2 is a flow diagram illustrating a process for mapping and monitoring deposit channels.

FIG. 3 is a table illustrating exemplary data resulting from mapping deposit channel information at one financial institution

FIG. 4 is a block diagram illustrating an exemplary computer system upon which embodiments of the invention may be implemented.

### DETAILED DESCRIPTION OF THE INVENTION

There are various embodiments and configurations for implementing the present invention. Generally, embodiments provide systems and methods for mapping deposit channels for one or more financial institutions in order to monitor the deposit channels and recognize significant variations from expected deposit channel activity.

As mentioned earlier, deposit channel information is useful to banks in detecting duplicate check transactions. Check transaction data may be submitted to a detection system to determine whether a check has been presented more than once, either to the same or two different financial institutions. The existence of duplicate items, and the deposit channel or type of presentment for the duplicate items, can be used in assessing the risk that the duplicate items may represent an actual fraud or may simply be false positives. Among other things, embodiments of the invention map and monitor deposit channel information at a financial institution in order to avoid false positives.

In some embodiments, deposit channel information from a financial institution is provided to a channel mapping system which alerts the financial institution when deposit channel data deviates from an expected range. For example, if the number of a certain type of check presentments at a bank (e.g., remote deposit by check image capturing) changes over time to an unexpected level, the channel mapping system may alert the financial institution.

It should be appreciated that the present invention is not limited to monitoring check transactions. Rather, in a broad sense, any transaction involving an instrument intended for single use or for only a defined number of uses can generate channel information that can be reviewed for fraud, and such channel information can be monitored in accordance with embodiments herein. As examples, such instruments may include, in addition to checks or negotiable instruments, single (or limited) use credit or debit cards, vouchers, gift cards, redemption certificates and any other instruments that have value and are intended for limited use.

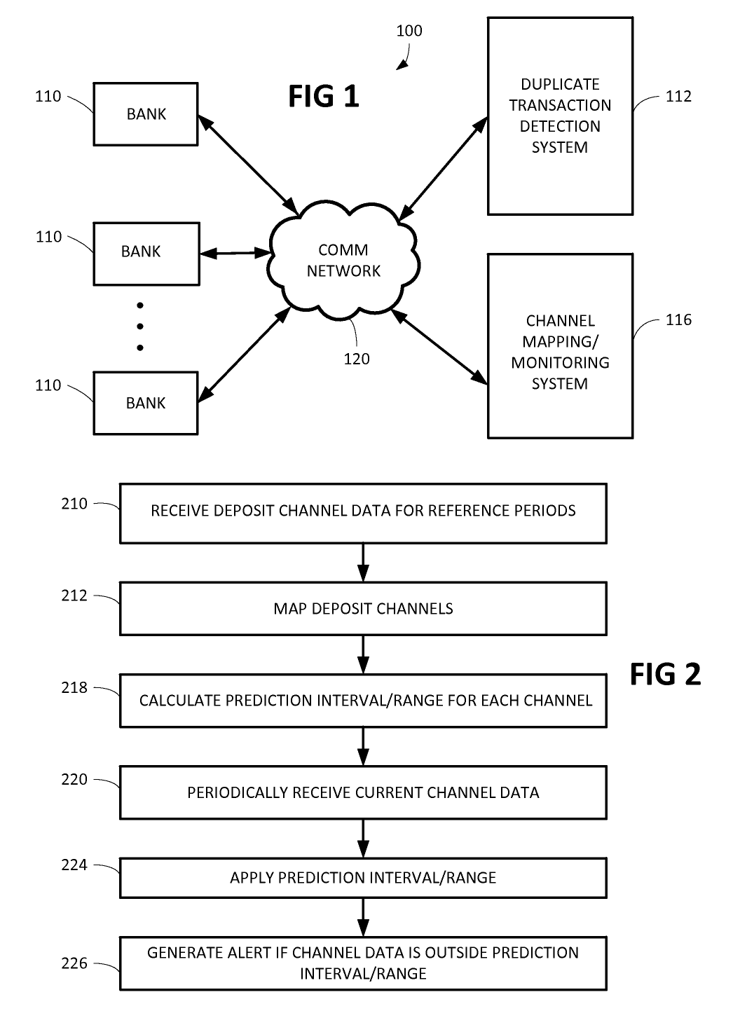

Referring now to the drawings, there is shown in FIG. 1 an exemplary network 100 in which a plurality of banks or other financial institutions 110 provide transaction-related data to a duplicate transaction detection system 112 and provide presentment-type information (deposit channel information) to a channel mapping/monitoring system 116. While the financial institutions 110 are illustrated as banks, it should be appreciated that, in some embodiments, other types of institutions may be involved in duplicate transaction detection and in channel monitoring, such as credit card companies and merchants that are involved in processing transactions or providing data pertaining to the manner in which transactions are conducted. The financial institutions 110 are connected through a communications network 120 (such as the Internet) to the duplicate transaction detection system 112 and the channel mapping/monitoring system 116.

In the described embodiment, the financial institutions 110 provide, through network 120 to the duplicate transaction detection system 112, data on negotiable instruments (checks) that have been presented for deposit or payment to determine if the same negotiable instrument has been presented for deposit/payment on more than one occasion. Further details of a duplicate transaction detection system such as the system 112 (and the manner of its operation) can be found in aforementioned U.S. application Ser. No. 13/451,039. In addition, as will be described in greater detail below, financial institutions 110 provide, through network 120 to the channel mapping/monitoring system 116, deposit channel information (information on presented negotiable instruments, specifically including the manner of presentment). Such information is used by system 116 for, among other things, recognizing trends or patterns in the presentment of negotiable instruments at the financial institutions 110 that may give rise to false positives at the duplicate transaction detection system 112.

Turning now to FIG. 2, there is illustrated a process implemented at the channel mapping/monitoring system 116 for evaluating deposit channel information from one of the financial institutions 110. At step 210, the system 116 receives deposit channel data/information from the financial institution. Deposit channel data, as mentioned earlier, indicates the type of presentment for a negotiable instrument at the financial institution. As an example, a financial institution may have a system that provides, with check information taken from a presented check, a deposit channel for the check, taken from the following table:

Deposit Channel Types

| Channel | Channel | Channel |
|---|---|---|
| Number | Name | Description |
| 0 | Unmatched/Undefined | The manner of deposit is |
| | | unknown or a bank chooses |
| | | not to provide a manner of |
| | | presentment. |
| 1 | Remote Deposit-All | All remote deposits (by image |
| | | capture), when a bank chooses |
| | | not to distinguish between |
| | | different types of remote |
| | | deposits. |
| 2 | Remote Deposit-Consumer | Deposit into a consumer |
| | | account. |
| 3 | Remote Deposit-Business | Deposit into a business |
| | | account. |
| 4 | In-Clearing | Frequently used for “on us” |
| | | checks, i.e., the deposited |
| | | check is drawn from an |
| | | account at the same bank |
| | | where the check is being |
| | | deposited; also used for |
| | | internal check-type |
| | | transactions, where internal |
| | | “checks” are written from one |
| | | department of a bank to |
| | | another department; also used |
| | | when no other deposit channel |
| | | is appropriate. |
| 5 | Branch/Teller | Deposit of a check using a |
| | | teller/clerk. |
| 6 | ATM | Deposit of a check at an ATM |
| 7 | Lockbox, Mail or Corporate | Checks deposited at an |
| | Account | overnight lockbox, through the |
| | | mail, or into an established |
| | | corporate account. |
| 8 | ACH | Electronic ACH (automated |
| | | clearinghouse) deposits. |
| 9 | Correspondent | Checks deposited at one bank |
| | | (often a smaller bank) that are |
| | | subsequently processed by a |
| | | another bank (often a larger |
| | | bank). |

It should be appreciated, because of overlapping or ambiguous designations, a single item or check may have information on presentment entered incorrectly or sometimes entered twice (for the same item) when the presentment might be construed by a bank employee or system as falling into more than one deposit channel, thus leading to the previously referenced “false positives” when doing duplicate item detection.

Returning to step 210, the deposit channel data received by the system 116 represents data from several reference time periods. For example, the reference periods could be deposit channel information on all checks deposited at a bank on each of several different days. As will be described shortly, the purpose of the data received at step 210 is to develop normal patterns of check presentment, and so a bank may be requested to present the deposit channel data for each of, say, six days in a previous month.

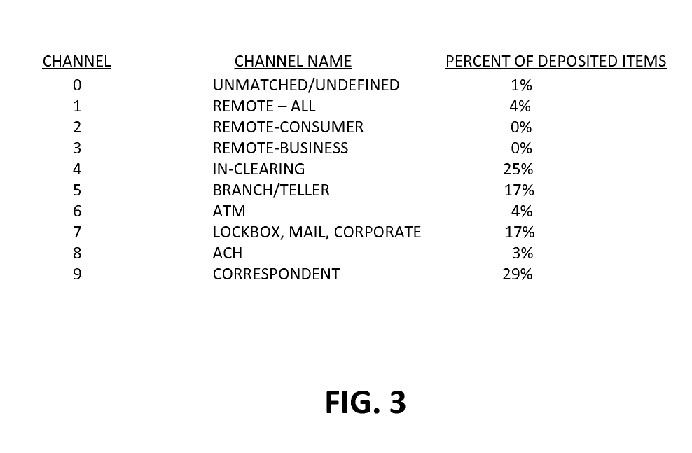

At step 212 the system 116 maps the deposit channels. In this step, mapping is the sorting of the data received at step 210 in order to provide a representation or “picture” of how the total number of presented checks are distributed over the set of possible deposit channels. This may be done by averaging the data for the six reference periods. An example of a mapping of deposit channels is illustrated in FIG. 3.

Referring to FIG. 3, the averaging of deposit channel data over several reference periods is shown for each of ten deposit channels (Channels 0-9). The average for each channel is shown as the percentage of checks (in relation to the total) that fall into each channel. The percentages range, in this particular example, from 0% (for “Remote-Consumer” and “Remote-Business”) to 29% for “Correspondent”). By way of explanation, remote deposits (involving image capture) are handled by banks differently, and in this example a bank has chosen to put all those deposits in Channel 1 rather than using Channels 2 and 3. Other banks might choose to put those deposits in either Channel 2 or Channel 3, and not use Channel 1.

Returning to FIG. 2, after the deposit channels have been mapped as illustrated in FIG. 3, the system 116 calculates a prediction interval or range for each channel, step 218. A specific example of one manner of calculating the prediction interval will be described later. However, by way of example, the result of the calculation may be of a range of ±3% (plus or minus three percent) around the historical average for that channel. The prediction interval reflects a variance in the deposit channel data for a given channel which would be considered normal or expected. Thus, if the exemplary range of ±3% was calculated for Channel No. 5 (“Branch/Teller”) in FIG. 3, deposits at the bank at a teller window on a given day could be within a prediction interval from 14% to 20% (17% ±3%) and be considered normal or expected.

At step 220, the system 116 periodically receives current deposit channel data from the same bank, e.g., deposit channel data for one day representing all checks deposited at that bank on that day), and the mapping of that current data (the percent of deposited items for each deposit channel) is compared or applied to the prediction interval calculated at step 224. If the current deposit channel data falls outside the prediction interval for any given channel, then an alert is generated and sent to the bank at step 226, indicating that abnormal or unexpected deposit channel activity has been detected.

In connection with the calculation of a prediction interval for referenced at step 218, the following exemplary formula could be used within system 116:

Prediction Interval=BLN_PCT±R(range), where R=(t-value)*Sn*I(1+1/n), and

where:

BLN_PCT is the average deposit channel percentage over the reference time periods, t-value is a calculated t-value, Sn is the standard deviation calculated for the BLN_PCT over the reference time periods, and n is the number of reference time periods.

For an exemplary calculation, if the BLN_PCT were 17%, the t-value were 0.67, the Sn were 4.1, and the value of n were 6, the range would be ±3%, with R being equal to 0.67 (t-value) times 4.1 (Sn) times 1.08 (square root of 1+⅙), thus providing a prediction interval 14%-20% (17%±3%).

As known to those skilled in the art, a t-value may be calculated from a user specified p value (the probability of obtaining a statistic result at least as extreme or as close to the one that was actually observed) and user specified degrees of freedom (number of values in the final calculation of a statistic that are free to vary), using statistical software, mathematical derivation, or looking up the value in a “t-table”. The t-value represents the value at which the probability of the random variable will be less than or equal to that probability. Further information on t-values can be found at “wikipedia.org/wiki/Student's_test.” In the exemplary embodiment above, the t-value was obtained from commercially available statistical software (SAS/STAT, from SAS Institute Inc., Cary, N.C.), using a p value of 0.05 and degrees of freedom of 5 (6 reference time periods minus 1).

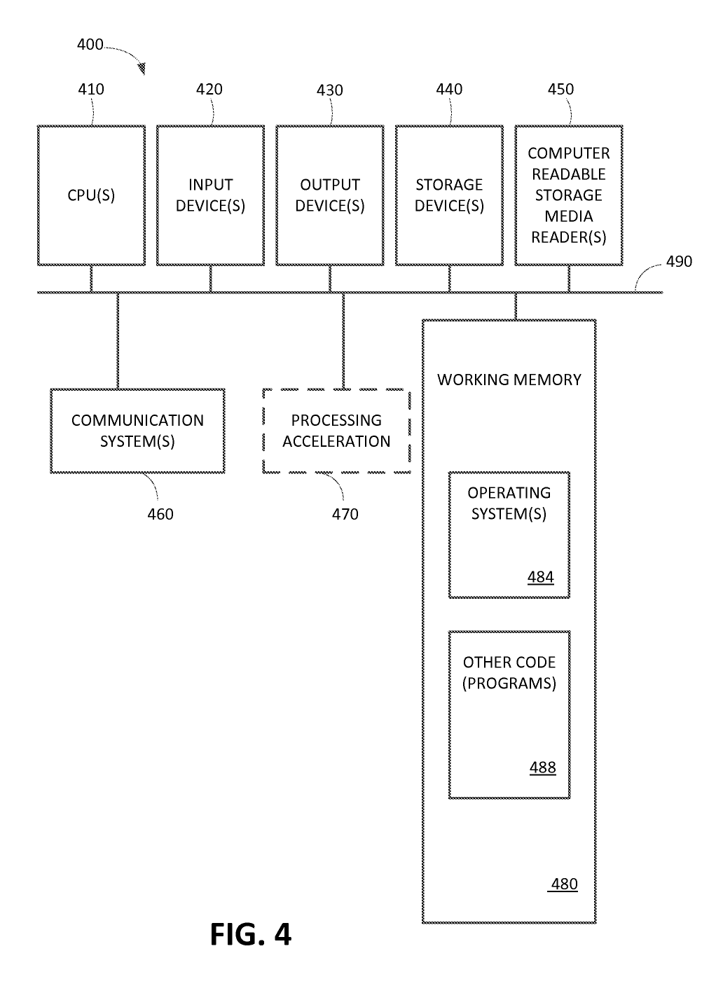

FIG. 4 is a block diagram illustrating an exemplary computer system upon which embodiments of the present invention may be implemented. This example illustrates a computer system 400 such as may be used, in whole, in part, or with various modifications, to provide the functions of the channel mapping/monitoring system 116, as well as other components and functions of the invention described herein.

The computer system 400 is shown comprising hardware elements that may be electrically coupled via a bus 490. The hardware elements may include one or more central processing units 410, one or more input devices 420 (e.g., a mouse, a keyboard, etc.), and one or more output devices 430 (e.g., a display device, a printer, etc.). The computer system 400 may also include one or more storage devices 440, representing remote, local, fixed, and/or removable storage devices and storage media for temporarily and/or more permanently containing computer-readable information, and one or more storage media reader(s) 450 for accessing the storage device(s) 440. By way of example, storage device(s) 440 may be disk drives, optical storage devices, solid-state storage devices such as a random access memory (“RAM”) and/or a read-only memory (“ROM”), which can be programmable, flash-updateable or the like.

The computer system 400 may additionally include a communications system 460 (e.g., a modem, a network card—wireless or wired, an infra-red communication device, a Bluetooth™ device, a near field communications (NFC) device, a cellular communication device, etc.). The communications system 460 may permit data to be exchanged with a network, system, computer, mobile device and/or other component as described earlier. The system 400 also includes working memory 480, which may include RAM and ROM devices as described above. In some embodiments, the computer system 400 may also include a processing acceleration unit 470, which can include a digital signal processor, a special-purpose processor and/or the like.

The computer system 400 may also comprise software elements, shown as being located within a working memory 480, including an operating system 484 and/or other code 488. Software code 488 may be used for implementing functions of various elements of the architecture as described herein. For example, software stored on and/or executed by a computer system, such as system 400, can be used in implementing the processes seen in FIG. 2.

It should be appreciated that alternative embodiments of a computer system 400 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the channel mapping/monitoring system 116 may be implemented by a single system having one or more storage device and processing elements. As another example, the channel mapping/monitoring system 116 may be implemented by plural systems, with their respective functions distributed across different systems either in one location or across a plurality of linked locations.

Moreover, while the various flows and processes described herein (e.g., those illustrated in FIG. 2) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims

What is claimed is:

1. A method for monitoring presentation of instruments to an institution, comprising:
receiving, from an institution, reference deposit channel information for each of a plurality of instruments presented to that institution, the reference deposit channel information representing instrument presentations into different deposit channels at the institution over each of a plurality of reference time periods;
mapping the reference deposit channel information for the plurality of reference time periods, to derive data reflecting the relative number of instrument presentations into each of the deposit channels for each of the plurality of reference time periods;
calculating, from the mapped reference deposit channel information for the plurality of reference time periods, prediction interval information representing an expected range of instrument presentations for each deposit channel that would reflect expected variations in deposit channel information;
receiving deposit channel information from the institution for a given time period under review, for monitoring the deposit channel information for that time period under review; and
comparing, for each deposit channel, the deposit channel information for the time period under review to the predicted interval information in order to determine if any deposit channel during the time period under review falls outside the expected range of instrument presentations.

2. The method of claim 1, wherein the institution is a financial institution.

3. The method of claim 2, where mapping the reference deposit channel information for the plurality of reference time periods comprises:
averaging the reference deposit channel information over the plurality of reference time periods for each of the deposit channels; and
providing the averaged reference deposit channel information for all of the deposit channels as the mapped reference deposit channel information for the plurality of deposit channels.

4. The method of claim 2, wherein the method further comprises alerting the financial institution if the deposit channel information for any deposit channel during the time period under review falls outside the expected range of instrument presentations.

5. The method of claim 2, wherein the instruments are negotiable instruments.

6. The method of claim 2, wherein the negotiable instruments are checks.

7. The method of claim 2, wherein the predicted interval information is calculated using the formula:
Prediction Interval=BLN_{—PCT±}R(range), where R=(t-value)*Sn*√(1+1/n), and where:
BLN_PCT is the average of deposit channel percentage over the reference time periods, t-value is a calculated t-value, Sn is the standard deviation calculated for the BLN_PCT over the reference time periods, and n is the number of reference time periods.

8. The method of claim 2, wherein each deposit channel is chosen from a group comprising: (1) Unmatched, (2) Remote Deposit-All, (3) Remote Deposit-Consumer, (4) Remote Deposit-Business, (5) In-Clearing, (6) Branch/Teller, (7) ATM, (8) Lockbox, Mail or Corporate Account, (9) ACH and (9) Correspondent.

9. The method of claim 2, wherein the financial institution is communicatively coupled to a channel mapping/monitoring system through a network, and wherein the financial institution is further communicatively coupled through the network to a duplicate transaction detection system, the duplicate transaction detection system alerting the financial institution in the event of possible fraud from the presentation of a same negotiable instrument for deposit on more than one occasion.

10. The method of claim 9, wherein the network is the Internet.

11. The method of claim 9, further comprising assessing, at the financial institution and based on determining that any deposit channel during the time period under review falls outside expected range of instrument presentations, whether possible fraud from the presentation of a same negotiable instrument for deposit on more than one occasion comprises a false positive.

12. A system for monitoring presentation of instruments to an institution, comprising:
a processor; and
a memory, the memory storing instructions that are executable by the processor and configure the system to:
receive, from an institution, reference deposit channel information for each of a plurality of instruments presented to that institution, the reference deposit channel information representing instrument presentations into different deposit channels at the institution over each of a plurality of reference time periods;
map the reference deposit channel information for the plurality of reference time periods, to derive data reflecting the relative number of instrument presentations into each of the deposit channels for each of the plurality of reference time periods;
calculate, from the mapped reference deposit channel information for the plurality of reference time periods, prediction interval information representing an expected range of instrument presentations for each deposit channel that would reflect expected variations in deposit channel information;
receive deposit channel information from the institution for a given time period under review, for monitoring the deposit channel information for that time period under review; and
compare, for each deposit channel, the deposit channel information for the time period under review to the predicted interval information in order to determine if any deposit channel during the time period under review falls outside the expected range of instrument presentations.

13. The system of claim 12, wherein the institution is a financial institution.

14. The system of claim 13, where configuring the system to map the reference deposit channel information for the plurality of reference time periods comprises:
averaging the reference deposit channel information over the plurality of reference time periods for each of the deposit channels; and
providing the averaged reference deposit channel information for all of the deposit channels as the mapped reference deposit channel information for the plurality of deposit channels.

15. The system of claim 13, wherein the memory stores instructions that are executable by the processor to further configure the system to alert the financial institution if the deposit channel information for any deposit channel during the time period under review falls outside the expected range of instrument presentations.

16. The system of claim 13, wherein the instruments are negotiable instruments.

17. The system of claim 13, wherein the negotiable instruments are checks.

18. The system of claim 13, wherein the predicted interval information is calculated using the formula:
Prediction Interval=BLN_PCT±R(range), where R=(t-value)*Sn*I(1+1/n), and where:
BLN_PCT is the average of deposit channel percentage over the reference time periods, t-value is a calculated t-value, Sn is the standard deviation calculated for the BLN_PCT over the reference time periods, and n is the number of reference time periods.

19. The system of claim 13, wherein each deposit channel is chosen from a group comprising: (1) Unmatched, (2) Remote Deposit-All, (3) Remote Deposit-Consumer, (4) Remote Deposit-Business, (5) In-Clearing, (6) Branch/Teller, (7) ATM, (8) Lockbox, Mail or Corporate Account, (9) ACH and (9) Correspondent.

20. The system of claim 13, wherein the financial institution is communicatively coupled to the system through a network, and wherein the financial institution is further communicatively coupled through the network to a duplicate transaction detection system, the duplicate transaction detection system alerting the financial institution in the event of possible fraud from the presentation of a same negotiable instrument for deposit on more than one occasion.

21. The system of claim 20, wherein the network is the Internet.

22. The system of claim 20, wherein the memory stores instructions that are executable by the processor to further configure the system to assess, at the financial institution and based on determining that any deposit channel during the time period under review falls outside expected range of instrument presentations, whether possible fraud from the presentation of a same negotiable instrument for deposit on more than one occasion comprises a false positive.
